(19) United States
(12) Patent Application Publication
(10) Pub. No.: US 2015/0204547 A1
(43) Pub. Date: Jul. 23, 2015

(54) COOKING OVEN WITH AN OVEN CAVITY AND A STEAM COOKING ARRANGEMENT

(71) Applicant: Electrolux Home Products Corporation N.V., Brussels (BE)

(72) Inventor: Tomasso Raggi, Forli (IT)

(21) Appl. No.: 14/417,667

(22) PCT Filed: Aug. 14, 2013
(86) PCT No.: PCT/EP2013/066989

§ 371 Date: Jan. 27, 2015

(30) Foreign Application Priority Data
Aug. 31, 2012 (EP) 12182609.3

(51) Int. Cl. F24C 15/32; A47J 27/04

(52) U.S. Cl. CPC F24C 15/327; A47J 27/04; A47J 2027/043

(57) ABSTRACT

The present invention relates to cooking oven (10) with an oven cavity (20) and a steam cooking arrangement. The steam cooking arrangement comprises a water reservoir (22) for storing water, at least one steam generator (18) connected to the water reservoir (22) and provided for heating up and vaporizing the water from the water reservoir (22), and at least one steam nozzle arranged at a wall of the oven cavity (20) and provided for inducing steam into said oven cavity (20). The steam cooking arrangement comprises further at least one steam pipe (24) interconnected between the steam generator (18) and the steam nozzle and provided for conveying steam, a water drain valve (30) provided for emptying the water reservoir (22), and a water drain conduit (26, 28) interconnected between the water reservoir (22) and the water drain valve (30). The water drain conduit includes a flexible pipe (28) arranged or arrangeable in a rest position and in a working position, wherein the flexible pipe (28) is accommodated in a bent configuration inside the cooking oven (10) in the rest position, and wherein the flexible pipe (28) extends out of the cooking oven (10) for draining water in the working position.

The present invention relates to a cooking oven with an oven cavity and a steam cooking arrangement according to the preamble of claim 1.

A conventional steam cooking arrangement for a cooking oven comprises usually a water reservoir, a steam generator, a steam pipe, a steam nozzle, a water drain conduit and a water drain valve. The steam generator heats up and vaporizes water from the water reservoir. The steam nozzle introduces the resulting steam from the steam generator into the oven cavity of the cooking oven. The water drain conduit and the water drain valve form an emptying system. The water drain conduit is typically formed as a rigid tube and the water drain valve is at the end of said tube. The rigid tube is usually made of metal, while the water drain valve is mostly made of plastics.

The water drain valve can be opened by the user, when remaining water after usage should be removed from the water reservoir and the drain conduit. The water drain valve must be carefully opened by the user in order to avoid leakage and damages. Moreover, a tool or a special device, like an actuator, is required for operating the water drain valve. Additionally, the user has to handle at the same time the water drain valve and/or the actuator and a water container that the user has to provide for collecting water removed from the water reservoir; such operation being rather complicated.

It is an object of the present invention to provide a cooking oven with a steam cooking arrangement, wherein the steam cooking arrangement is easy to handle by low complexity.

The object of the present invention is achieved by the cooking oven according to claim 1.

According to the present invention the water drain conduit includes a flexible pipe arranged or arrangeable in a rest position and in a working position, wherein the flexible pipe is accommodated in a bent configuration inside the cooking oven in the rest position, and wherein the flexible pipe extends out of the cooking oven for draining water in the working position.

The core of the present invention is the flexible pipe on the one hand and the mobility between the rest position and working position of said flexible pipe on the other hand. The rest position of the flexible pipe is obtained by pushing said flexible pipe into the cooking oven. The working position of the flexible pipe is obtained by pulling said flexible pipe out of the cooking oven. The flexible pipe is easily movable between the rest position and the working position by the user. The flexible pipe and the water drain valve allow low complexity. There are no assembly operations for the draining water procedure. The user has only to pull out the flexible tube and to open the water drain valve. Then, the user has to close the water drain valve and to push in the flexible tube again. The draining water procedure is very easy and the risk of wetting the cooking oven is avoided. The water can flow away from the cooking oven.

Further, the water drain conduit may be entirely formed by the flexible pipe or it may include a rigid water drain pipe interconnected between the water reservoir and the flexible pipe. Thus, the water conduit between the water reservoir and the water drain valve comprises a rigid and a flexible portion.

In particular, the water drain valve is an integral end part of the flexible pipe. This contributes to a low complexity.

The water drain valve may be arranged or arrangeable at a wall of the cooking oven or oven chassis in the rest position. Thus, the water drain valve and the end of the flexible pipe are accessible by the user in an easy way.

For example, the water drain valve is arranged or arrangeable at a front wall or front panel of the cooking oven in the rest position.

Alternatively, the water drain valve may be arranged or arrangeable at a front wall of an oven chassis of the cooking oven in the rest position. In this case, the water drain valve may be arranged or arrangeable at a flange of the oven cavity.

In contrast, the water drain valve may be arranged or arrangeable spaced apart from the cooking oven in the working position.

Preferably, the water drain valve is arranged or arrangeable spaced apart from the front side of the cooking oven in the working position.

Further, the flexible pipe may be arranged or arrangeable in an intermediate space between a sidewall of the oven cavity and a sidewall of the oven chassis.

Moreover, the steam cooking arrangement may comprise a fill port arranged at an upper front panel of the cooking oven.

The steam cooking arrangement may comprise a water supply pipe interconnected between the fill port and the water reservoir. Preferably, the water supply pipe is arranged above the oven cavity.

According to the preferred embodiment of the present invention the water reservoir is arranged at the rear side of the cooking oven.

In a similar way, the steam generator may be arranged at the rear side of the cooking oven.

Further, the water drain valve comprises a tap for opening and closing said water drain valve. The tap allows an easy handling for the user.

The water drain valve may be embodied as a cap associated to the flexible pipe, said cap being insertable into and removable from an end portion of the flexible pipe.

Preferably, the flexible pipe is made of at least one plastic material.

In particular, the flexible pipe is made of at least one antibacterial plastic material.

More particularly, the flexible pipe is made of at least a food compliant material, i.e. a material that may enter in contact with food without alter its edibility properties in a manner that may cause risk for user health.

The novel and inventive features believed to be the characteristic of the present invention are set forth in the appended claims.

The invention will be described in further detail with reference to the drawings, in which

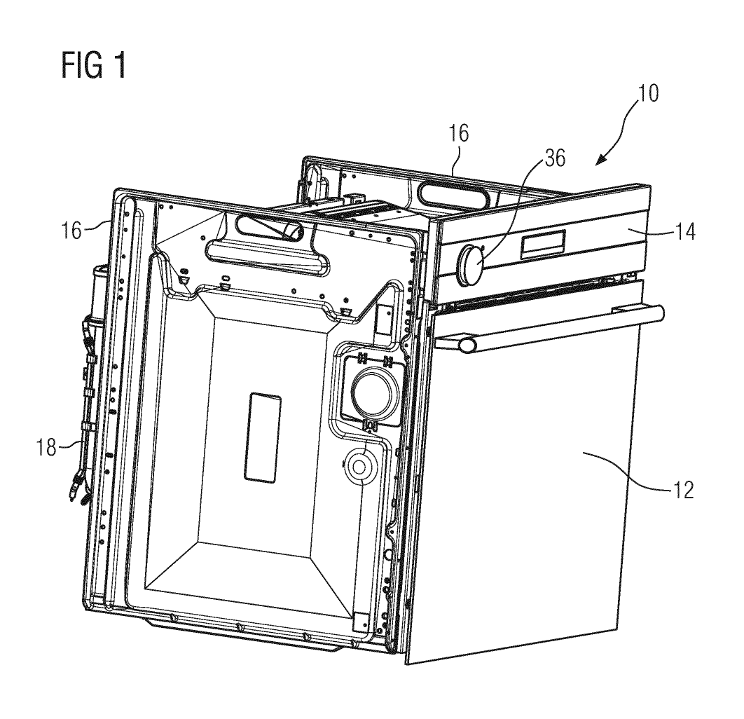

FIG. 1 illustrates a perspective view of a cooking oven with a steam cooking arrangement according to a preferred embodiment of the present invention,

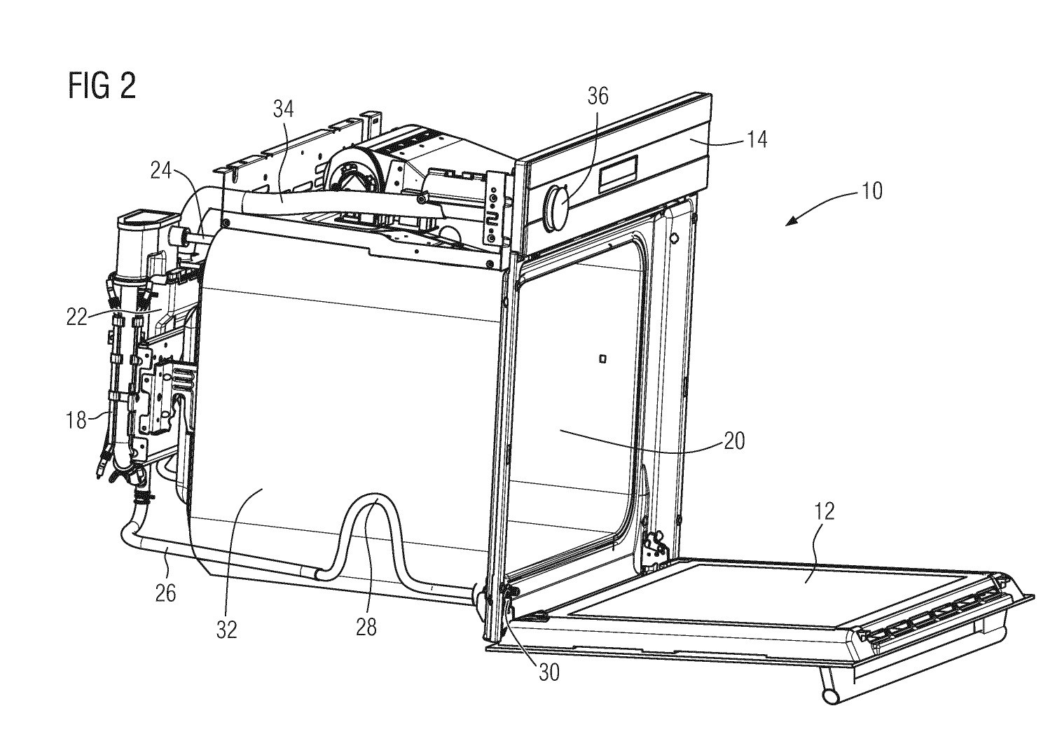

FIG. 2 illustrates a perspective view of the cooking oven with the steam cooking arrangement according to the preferred embodiment of the present invention, wherein the sidewalls of the oven chassis has been removed and a flexible pipe is in a rest position,

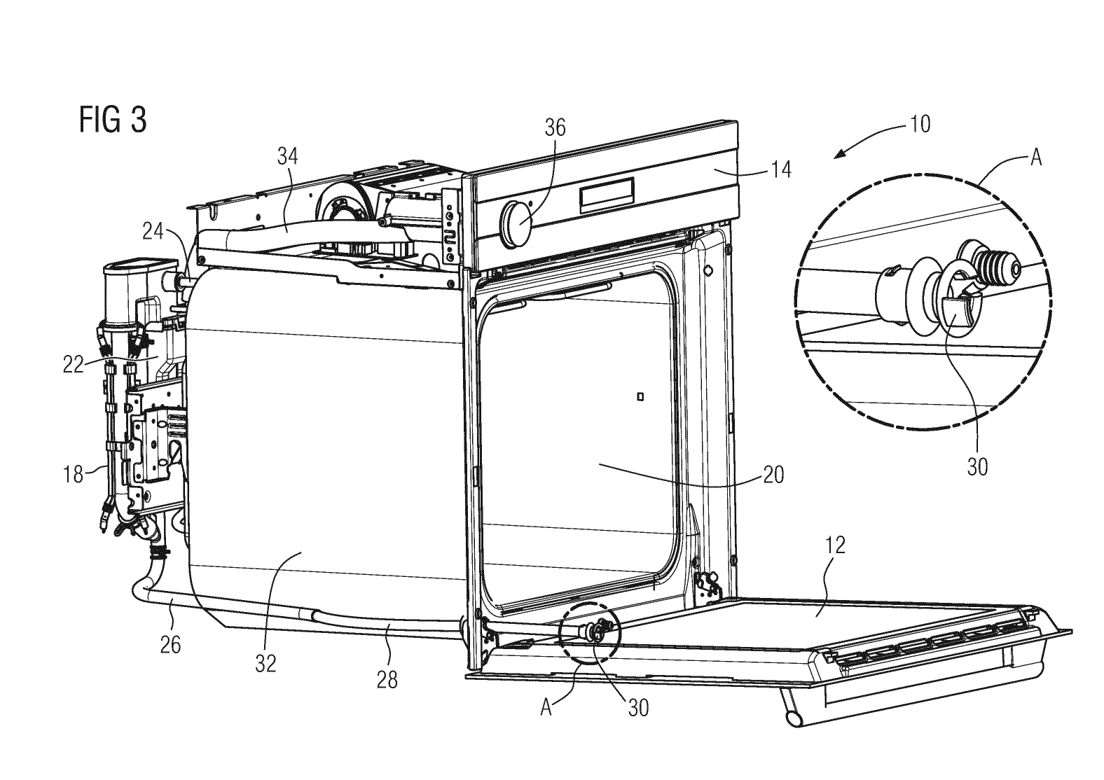

FIG. 3 illustrates a perspective view of the cooking oven with the steam cooking arrangement according to the preferred embodiment of the present invention, wherein the sidewalls of the oven chassis has been removed and the flexible pipe is in a working position, and

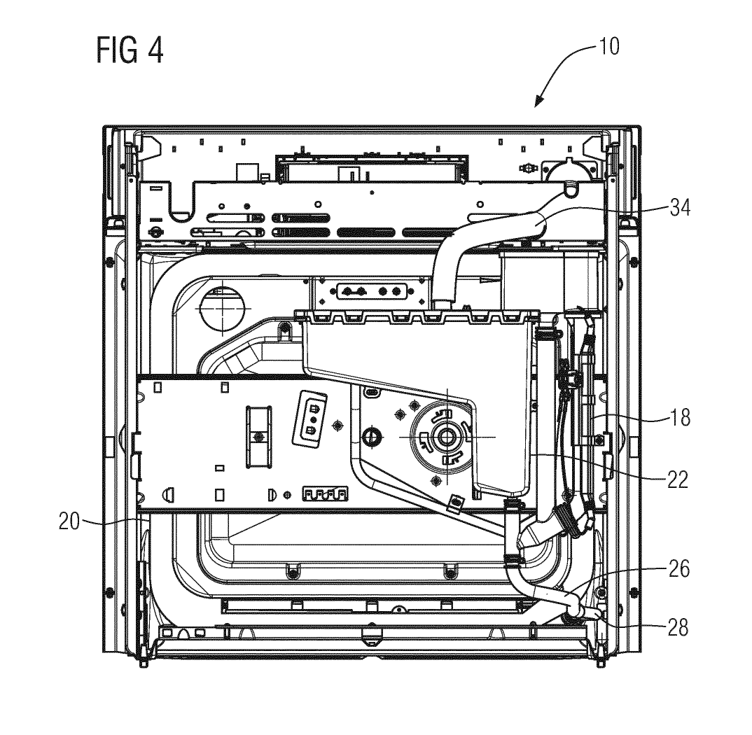

FIG. 4 illustrates a rear view of the cooking oven with the steam cooking arrangement according to the preferred embodiment of the present invention.

FIG. 1 illustrates a perspective view of a cooking oven 10 with a steam cooking arrangement according to a preferred embodiment of the present invention. The cooking oven 10 comprises an oven door 12 and an upper front panel 14 at its front side. In FIG. 1 the oven door 12 is closed. A fill port 36 is arranged at the upper front panel 14. The oven chassis of the cooking oven 10 comprises two sidewalls 16. The steam cooking arrangement of the cooking oven 10 includes a steam generator 18 arranged at the rear side of the oven chassis.

FIG. 2 illustrates a perspective view of the cooking oven 10 with the steam cooking arrangement according to the preferred embodiment of the present invention, wherein the sidewalls 16 of the oven chassis are removed and a flexible pipe 28 is in a rest position. In FIG. 2 the oven door 12 is open. The cooking oven 10 comprises an oven cavity 20 closable by the oven door 12.

The steam cooking arrangement of the cooking oven 10 includes the steam generator 18, a water reservoir 22, a steam pipe 24, a steam nozzle, a water drain pipe 26, a flexible pipe 28, a water drain valve 30, a water supply pipe 34 and the fill port 36.

The steam generator 18 and the water reservoir 22 are arranged at the rear side of the cooking oven 10. The steam nozzle is arranged at the top side of the oven cavity 20. The steam nozzle is not shown. The steam pipe 24 is interconnected between the steam generator 18 and the steam nozzle. The steam generator 18 heats up and vaporizes water from the water reservoir 22. The resulting steam is conveyed by the steam pipe 24 to the steam nozzle. The steam nozzle introduces the steam into the oven cavity 20.

The water drain pipe 26 and the flexible pipe 28 are connected in series. The water drain pipe 26 is a rigid pipe. The water drain pipe 26 and the flexible pipe 28 are interconnected between the water reservoir 22 and the water drain valve 30. The water drain pipe 26 and the flexible pipe 28 are provided for emptying the water reservoir 22, wherein the water flows out through the water drain valve 30. Thereby, the water passes at first the water drain pipe 26, then the flexible pipe 28, and at last the water drain valve 30. The water drain pipe 26 and the flexible pipe 28 are arranged between a left sidewall 32 of the oven cavity 20 and the left sidewall 16 of the oven chassis.

In FIG. 2 the flexible pipe 28 is in the rest position. The flexible pipe 28 is moveable into and removable from the intermediate space between the left sidewall 32 of the oven cavity 20 and the left sidewall 16 of the oven chassis. In the rest position the complete portion of the flexible pipe 28 is substantially in the intermediate space between the left sidewall 32 of the oven cavity 20 and the left sidewall 16 of the oven chassis. The flexible pipe 28 is squeezed in the rest position, so that the shape of the flexible pipe 28 comprises curves. The water drain valve 30 forms an integral end part of the flexible pipe 28. In the rest position, the water drain valve 30 is arranged at a front side of the oven chassis. If the oven door 12 is closed, then the water drain valve 30 is behind said oven door 12 in the rest position.

The water supply pipe 34 is interconnected between the water reservoir 22 and the fill port 36 at the upper front panel 14 of the cooking oven 10. The water supply pipe 34 allows that the water reservoir 22 may be filled by the user from the fill port 36 at the upper front panel 14.

FIG. 3 illustrates a perspective view of the cooking oven 10 with the steam cooking arrangement according to the preferred embodiment of the present invention, wherein the sidewalls of the oven chassis has been removed and the flexible pipe 28 is a working position. FIG. 3 differs from FIG. 2 in the arrangement and position of the flexible pipe 28.

In the working position of the flexible pipe 28, a front portion of said flexible pipe 28 is pulled out of the cooking oven 10, while a rear portion of the said flexible pipe 28 remains in the intermediate space between the left sidewall 32 of the oven cavity 20 and the left sidewall 16 of the oven chassis. The shape of the flexible pipe 28 is substantially linear. In the working position, there is a downward slope from the water reservoir 22 via the water drain pipe 26 and the flexible pipe 28 to the water drain valve 30. Thus, in the working position of the flexible pipe 28 the user can empty the water reservoir 22. In the working position, the water drain valve 30 is arranged in front of the oven chassis and above the open oven door 12.

The working position of the flexible pipe 28 is obtained by pulling out the front portion of said the flexible pipe 28 of the intermediate space by the user. Accordingly, the rest position of the flexible pipe 28 is obtained by pushing in the front portion of said the flexible pipe 28 into the intermediate space by the user.

FIG. 4 illustrates a rear view of the cooking oven 10 with the steam cooking arrangement according to the preferred embodiment of the present invention.

The steam generator 18 and the water reservoir 22 are arranged at the rear side of the cooking oven 10. The water supply pipe 34 is arranged above the water reservoir 22 and oven cavity 20. The water drain pipe 26 and the flexible pipe 28 are arranged below the water reservoir 22. Further, the water drain pipe 26 and the flexible pipe 28 are arranged below and/or beside the oven cavity 20.

The flexible pipe 28 is movable between the rest position and the working position by the user. In the rest position the flexible pipe 28 is accommodated in a bent configuration inside the cooking oven 10. In the working position the flexible pipe 28 extends out of the cooking oven 10 for draining water. The water drain pipe 26, the flexible pipe 28 and the water drain valve 30 allow low complexity.

There are no assembly operations for the draining water procedure. The user has only to pull the flexible tube 28 out of the cooking oven 10 and to open the water drain valve 30. Then, the user has to close the water drain valve 30 and to push the flexible tube 28 into the cooking oven 10 again.

The user may orient the flexible pipe 28 and the water drain valve 30 according to the requirements. The draining water procedure is very easy and the risk of wetting the cooking oven 10 is avoided. The water can flow away from the cooking oven 10.

The water drain valve 30 can be realized by low complexity. A simple tap may be used as or instead of the water drain valve 30. Alternatively, the water drain valve may be embodied as a cap associated to the flexible pipe, said cap being insertable into and removable from an end portion of the flexible pipe.

The flexible pipe 28 can be easily installed inside the cooking oven 10. The flexible pipe 28 requires no support elements along the pipe path.

The flexible pipe 28 may be made of plastic materials. In particular, the flexible pipe 28 may be made of antibacterial plastic materials.

Although an illustrative embodiment of the present invention has been described herein with reference to the accompanying drawings, it is to be understood that the present invention is not limited to that precise embodiment, and that various other changes and modifications may be affected therein by one skilled in the art without departing from the scope of the invention. All such changes and modifications are intended to be included within the scope of the invention as defined by the appended claims.

### LIST OF REFERENCE NUMERALS

10 cooking oven

12 oven door

14 upper front panel

16 sidewall of the oven chassis

18 steam generator

20 oven cavity

22 water reservoir

24 steam pipe

26 water drain pipe

28 flexible pipe

30 water drain valve

32 sidewall of the oven cavity

34 water supply pipe

36 fill port

1. A cooking oven (10) with an oven cavity (20) and a steam cooking arrangement, wherein said steam cooking arrangement comprises:
a water reservoir (22) for storing water,
at least one steam generator (18) connected to the water reservoir (22) and provided for heating up and vaporizing the water from the water reservoir (22),
at least one steam nozzle arranged at a wall of the oven cavity (20) and provided for inducing steam into said oven cavity (20),
at least one steam pipe (24) interconnected between the steam generator (18) and the steam nozzle and provided for conveying steam,
a water drain valve (30) provided for emptying the water reservoir (22), and
a water drain conduit (26, 28) interconnected between the water reservoir (22) and the water drain valve (30),
characterized in, that
the water drain conduit includes a flexible pipe (28) arranged or arrangeable in a rest position and in a working position, wherein the flexible pipe (28) is accommodated in a bent configuration inside the cooking oven (10) in the rest position, and wherein the flexible pipe (28) extends out of the cooking oven (10) for draining water in the working position.

2. The cooking oven according to claim 1, characterized in, that the water drain conduit includes a rigid water drain pipe (26) interconnected between the water reservoir (22) and the flexible pipe (28).

3. The cooking oven according to claim 1, characterized in, that the water drain valve (30) is an integral end part of the flexible pipe (28).

4. The cooking oven according to claim 1, characterized in, that the water drain valve (30) is arranged or arrangeable at a front wall or front panel of the cooking oven (10) in the rest position.

5. The cooking oven according to claim 1, characterized in, that the water drain valve (30) is arranged or arrangeable at a front wall of an oven chassis of the cooking oven (10) in the rest position.

6. The cooking oven according to claim 1, characterized in, that the water drain valve (30) is arranged or arrangeable spaced apart from the cooking oven (10) in the working position.

7. The cooking oven according to claim 6, characterized in, that the water drain valve (30) is arranged or arrangeable spaced apart from the front side of the cooking oven (10) in the working position.

8. The cooking oven according to claim 1, characterized in, that the flexible pipe (28) is arranged or arrangeable in an intermediate space between a sidewall (32) of the oven cavity (20) and a sidewall (16) of the oven chassis.

9. The cooking oven according to claim 1, characterized in, that the steam cooking arrangement comprises a fill port (36) arranged at an upper front panel (14) of the cooking oven (10).

10. The cooking oven according to claim 9, characterized in, that the steam cooking arrangement comprises a water supply pipe (34) interconnected between the fill port (36) and the water reservoir (22).

11. The cooking oven according to claim 1, characterized in, that the water reservoir (22) is arranged at the rear side of the cooking oven (10).

12. The cooking oven according to claim 1, characterized in, that the steam generator (18) is arranged at the rear side of the cooking oven.

13. The cooking oven according to claim 1, characterized in, that the water drain valve (30) comprises a tap for opening and closing said water drain valve (30).

14. The cooking oven according to claim 1, characterized in, that the flexible pipe (28) is made of at least one plastic material.

15. The cooking oven according to claim 1, characterized in, that the flexible pipe (28) is made of at least one antibacterial plastic material.
